(19) United States
(12) Patent Application Publication
(10) Pub. No.: US 2019/0312918 A1
(43) Pub. Date: Oct. 10, 2019

(54) SYSTEM AND METHOD FOR PROVIDING A RICH USER EXPERIENCE FOR CELLULAR CALLS

(71) Applicant: Avaya Inc., Santa Clara, CA (US)

(72) Inventors: Mehmet Balasaygun, Freehold, NJ (US); Kurt Haserodt, Westminster, CO (US)

(21) Appl. No.: 15/948,631

(22) Filed: Apr. 9, 2018

(51) Int. Cl. H04L 29/06; H04L 29/08

(52) U.S. Cl. CPC H04L 65/403; H04W 88/02; H04L 67/26

(57) ABSTRACT

An invitation is received from a cell phone application in a mobile device to join or establish a conference session. A determination is made that the invitation to join or establish the conference session is from a cellular network. For example, the invitation may be based on a known cellular telephone number in the request to join or establish the conference session. A push notification message is sent to a push notification service. The push notification message causes a conferencing application on the mobile device to become active. For example, the push notification message may cause the conferencing application to be launched in the mobile device. A message is received that indicates the conferencing application is active. Information is sent associated with the conference session to the active conferencing application. The information is then displayed to a user. An embodiment is also described for a collaboration application.

### FIELD

The disclosure relates generally to call management systems and particularly to conferencing and collaboration call management.

### BACKGROUND

With today's Voice over Internet Protocol (VoIP) technology, many of the current VoIP applications provide capabilities that go over and beyond a basic phone call. For example, when a user of a conferencing system connects to a conference call, the VoIP application can present a conference view of the conference call, display a web collaboration, display a roster list for the conference call, and an active talker indication of who is currently speaking in the conference call. This process works well when the call is placed using the VoIP application. However, in a situation where the user does not have good data network coverage for real time audio communications, it is possible for the user to dial in or start a conference call using the cellular network by using the cell phone's built-in cellular application. In this case, the user does not have access to these additional services.

### SUMMARY

These and other needs are addressed by the various embodiments and configurations of the present disclosure. An invitation is received from a cell phone application in a mobile device to join or establish a conference session. A determination is made that the invitation to join or establish the conference session is from a cellular network. For example, the invitation may be based on a known cellular telephone number in the request to join or establish the conference session. A push notification message is sent to a push notification service. The push notification message causes a conferencing application on the mobile device to become active. For example, the push notification message may cause the conferencing application to be launched in the mobile device. A message is received that indicates the conferencing application is active. Information is sent associated with the conference session to the active conferencing application. The information is then displayed to a user.

In another embodiment, an invitation is received, by a communication system, from a cell phone application in a mobile device to establish a communication session with a communication endpoint. A determination is made that the invitation to establish the communication session is from a cellular network. A push notification message is sent to a push notification service. The push notification message causes a collaboration application on the mobile device to become active. A message is received that the collaboration application is active. In response to receiving the message that the collaboration application is active, a collaboration session is established between the mobile device and the communication endpoint.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The term “cellular network” as defined herein is where voice, video, and/or virtual reality calls are made using the built-in cellular application in the cell phone to access a carrier's cellular network. For cellular telephones, the user typically has access to the cellular network (e.g., for voice/video calls) and access to a data network (for Internet Access). For example, a user may go to AT&T® and purchase a cell phone that has unlimited voice calls and a limit of ten Gigs of Internet access each month. As described herein, the term “cellular network” does not include the data network that is used by the cellular telephone to access the Internet or data services.

As described herein, the terms “call” and “session” may be used interchangeably. For example, a conference call means the same thing as a conference session.

The term “conference session” is any communication session where two or more user are connected and communication using voice, video, or virtual reality communications.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for providing a rich user experience for cellular conference calls.

FIG. 2 is a block diagram of a second illustrative system for providing a rich user experience for cellular collaboration calls.

FIG. 3 is a flow diagram of a process for providing a rich user experience for cellular conference calls.

FIG. 4 is a flow diagram of a process for providing a rich user experience for cellular collaboration calls.

### DETAILED DESCRIPTION

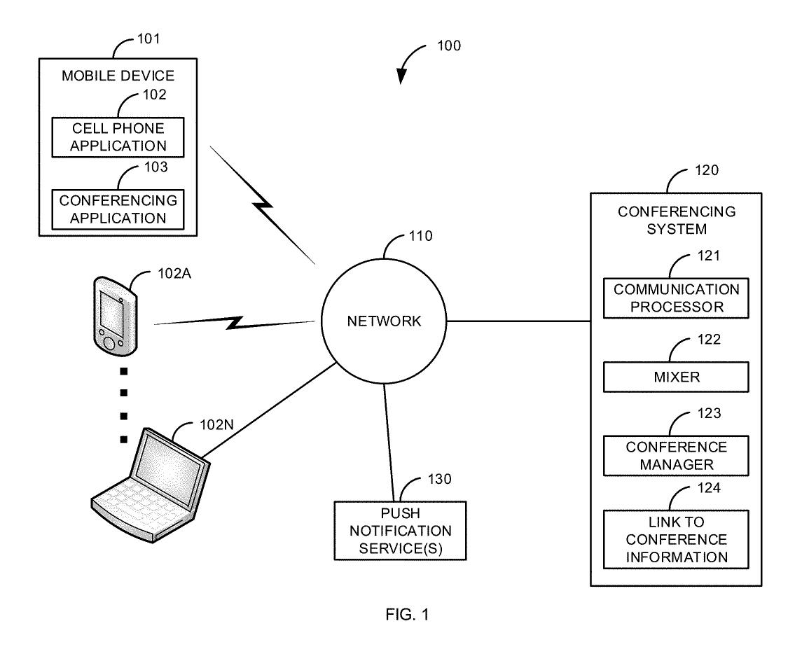

FIG. 1 is a block diagram of a first illustrative system 100 for providing a rich user experience for cellular conference calls. The first illustrative system 100 comprises a mobile device 101, communication endpoints 102A-102N, a network 110, a conferencing system 120, and push notification service(s) 130.

The mobile device 101 can be or may include any mobile device 101 that can communicate on a cellular network (e.g., network 110), such as, a cellular telephone, a Personal Digital Assistant (PDA), a tablet device, a laptop device, a notebook device, a smartphone, and/or the like. Although not shown, there may be other mobile devices 101 connected to the network 110 that may use the processes described herein.

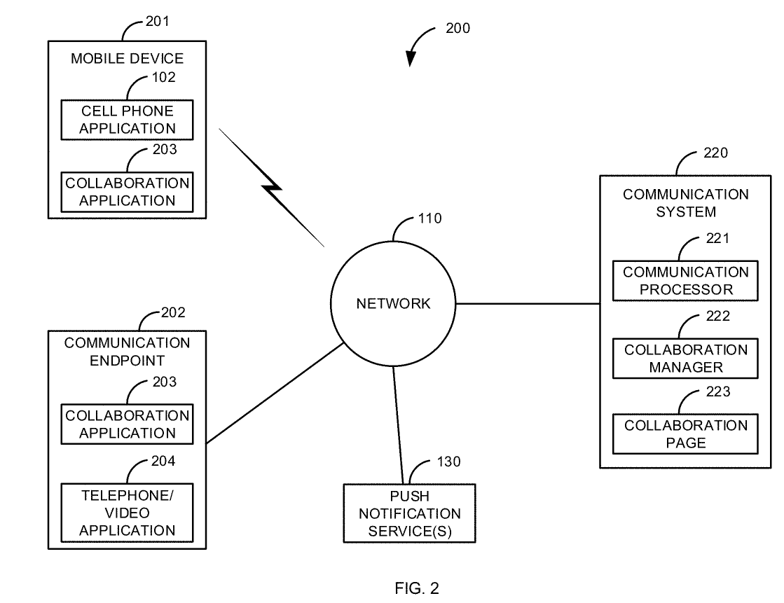

The mobile device 101 further comprises a cellphone application 102 and a conferencing application 103. Although not shown, the mobile device 101 may comprise other applications. For example, the mobile device 101 may comprise a collaboration application 203 (shown in FIG. 2).

The cell phone application 102 can be or may include any cell phone application 102 that can establish a voice, a video, and/or a virtual reality communication session using a cellular network 110. The cell phone application 102 is typically pre-installed (built-in) on the mobile device 101 before a user purchases the mobile device 101.

The conferencing application 103 can be or may include any software application that can be loaded or installed onto the mobile device 101. The conferencing application 103 communicates with the conference manager 123 to provide additional services for a conference call where the user is using the cell phone application 102. The conferencing application 103 can provide various services in a conference call, such as, a roster, identification of an active talker in a conference call, a list of invited participants in the conference call, a list of phone numbers, an ability call another user and add the other user to the conference call, a graphical display of a structure of the conference call, location information of participants in the conference call, and/or the like. In one embodiment, the conferencing application 103 may be a web based conferencing application that runs in a browser (not shown).

The communication endpoints 102A-102N can be or may include any communication endpoint device that can communicate on the network 110, such as a Personal Computer (PC), a telephone, the mobile device 101, a video phone, a desktop computer, and/or the like. The communication endpoints 102A-102N are devices where a communication session ends. The communication endpoints 102A-102N are not network elements that facilitate and/or control communication sessions in the network 110, such as a communication manager or router. As shown in FIG. 1, any number of communication endpoints 102A-102N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, multiple cellular networks, a combination of these, and the like. The network 110 can use a variety of electronic protocols, such as Ethernet, Internet Protocol (IP), Session Initiation Protocol (SIP), Integrated Services Digital Network (ISDN), Global System for Mobile Communications (GSM), General Packet Radio Service (GPRS), Interim Standard (IS-95), MIT Multi-Carrier IMT-MC, Enhanced GSM, Universal Mobile Telecommunications System (UMTS), and/or the like. Thus, the network 110 is an electronic communication network configured to carry messages (e.g., voice, video, data) via packets and/or circuit switched communications.

The conferencing system 120 can be or may include any hardware coupled with software that can manage a conference session. For example, the conferencing system 120 may be an Avaya Equinox™, an Avaya Aura® Conferencing system 120, and/or the like. The conference session may be an audio conference session, a video conference session, a virtual reality conference session, and/or the like. A conference session may comprise two or more mobile devices 101 and/or communication endpoints 102A-102N.

A virtual reality conference is where an avatar is displayed on behalf of the user to other users in the conference session. The Avatar may be able to be moved by the user to talk with other users in a virtual reality setting.

The conferencing system 120 further comprises a communication processor 121, a mixer 122, a conference manager 123, and a link to conference information 124. The communication processor 121 can be or may include any hardware coupled with software that can manage connection of users to a conference session, such as a Private Branch Exchange (PBX), a session manager, a router, a switch, and/or the like. The communication processor 121 may receive and/or initiate requests for a conference session.

The mixer 122 can be or may include any hardware coupled with software that can mix signals for the conference session. The mixer 122 may mix audio, video, virtual reality signals and/or the like for the conference session. The mixer 122 may mix signals from mobile device(s) 101/communication endpoint(s) 102A-102N that communicate using different types of communication media. For example, the mobile device 101 may communicate using only audio while the communication endpoints 102A-102N may communicate using video (with audio) or virtual reality (with audio) in the conference session. The mixer 122 may mix voice/video/virtual reality for multiple concurrent conference sessions.

The conference manager 123 can be or may include any hardware coupled with software that can manage various aspects of a conference session. For example, the conference manager 123 may manage information regarding a conference session, such as, identifying a roster, identifying an active talker, managing a collaboration view, authenticating users (e.g., checking access codes), identifying who should be called for a conference call, using voice recognition to identify a speaker, identifying phone numbers of callers, managing a display of a video conference, and/or the like. The conference manager 123 may manage multiple concurrent conference sessions.

The link to conference information 124 may be web page (e.g., a Universal Resource Locator (URL)) that the conferencing application 103 uses to get information about a conference session. For example, the link to conference information 124 may be a link that shows a roster of current participants in a conference session. The link to conference information 124 may comprise a plurality of links to conference sessions. For example, there may be separate links to conference information 124 for two or more concurrent conference sessions.

The push notification service(s) 130 can be any known or envisioned push notification service 130, such as, Apple® Push Notification service 130, Google® Firebase Push Notification service 130, and/or the like. The push notification service(s) 130 allows for messages to be sent to applications (e.g., the conferencing application 103) on the mobile device 101 to be activated in response receiving a message from the push notification service 130. In one embodiment, the conferencing system 120 may use multiple push notification services 130. For example, one mobile device 101 may use the Apple® Push Notification service 130 (e.g., an iPhone®) and another mobile device 101 may use the Google® Firebase Push Notification service 130 (e.g., an Android® phone).

FIG. 2 is a block diagram of a second illustrative system 200 for providing a rich user experience for cellular collaboration calls. The second illustrative system 200 comprises a mobile device 201, a communication endpoint 202, the network 110, a communication system 220, and the push notification service(s) 130.

The mobile device 201 may be similar or the same as the mobile device 101. The mobile device 201 comprises the cell phone application 102 and a collaboration application 203. The mobile device 201 may also comprise other applications, such as, the conferencing application 103. Although not shown for simplicity, the second illustrative system 200 may comprise additional mobile devices 201.

The collaboration application 203 can be or may include any software that can provide collaboration services in a conference session. The collaboration application 203 may provide a view of collaboration session between the mobile device 201 and the communication endpoint 202. For example, the collaboration application 203 may provide a view of a slide presentation that is being presented in the collaboration session. In one embodiment, the collaboration application 203 may be an application that runs in a browser (not shown).

The communication endpoint 202 may be the same as or similar to (e.g., have the same or different software) the communication endpoint 101. The communication endpoint 202 further comprises the collaboration application 203 and a telephone/video application 204. The collaboration application 203 in the communication endpoint 202 may be the same or a different version of the collaboration application 203. For example, the collaboration application 203 on the mobile device 201 may be different from the collaboration application 203 on the communication endpoint 202 because they run on different operating systems (e.g., Android versus iOS). Although not shown for simplicity, the second illustrative system 200 may comprise additional communication endpoints 202.

The telephone/video application 204 can be or may include any application that can be used to establish a voice and/or video communication session with the cell phone application 102. For example, a voice call may be established from the mobile device 201 to the communication endpoint 202 via the communication system 220. Alternatively, a voice or video call may be established from the communication endpoint 202 to the mobile device 201 where the communication endpoint 202 uses the telephone/video application 204 to initiate the call.

The communication system 220 can be or may include any hardware coupled with software that can manage communications, such as, a PBX, a switch, a central office switch, a router, a proxy server, and/or the like. The communication system 220 further comprises a communication processor 221, a collaboration manager 222, and a collaboration page 223.

The communication processor 221 may the same as or similar to the communication processor 121. The communication processor 221 can be or may include any hardware coupled with software that can provide establishment, routing, and/or management of various types of communication sessions, such as voice, video, multi-media, virtual reality, and/or the like.

The collaboration manager 222 can be or may include any hardware coupled with software that can manage a collaboration session between the mobile device 201 and the communication endpoint 202. Although not shown, a collaboration session may comprise additional mobile devices 201 and/or communication endpoints 202. The collaboration manager may manage multiple concurrent collaboration sessions.

The collaboration page 223 may be a web page that is provided by a web server (not shown) to the mobile device 201/communication endpoint 202 as part of a collaboration session. In this embodiment, the collaboration application 203 connects to a URL provided to the collaboration manager 222 (e.g., the collaboration page 223). The collaboration page 223 may be provided as a video steam to the collaboration application 203. The collaboration page 223 may comprise a plurality of collaboration pages 223 for a plurality of concurrent collaboration sessions.

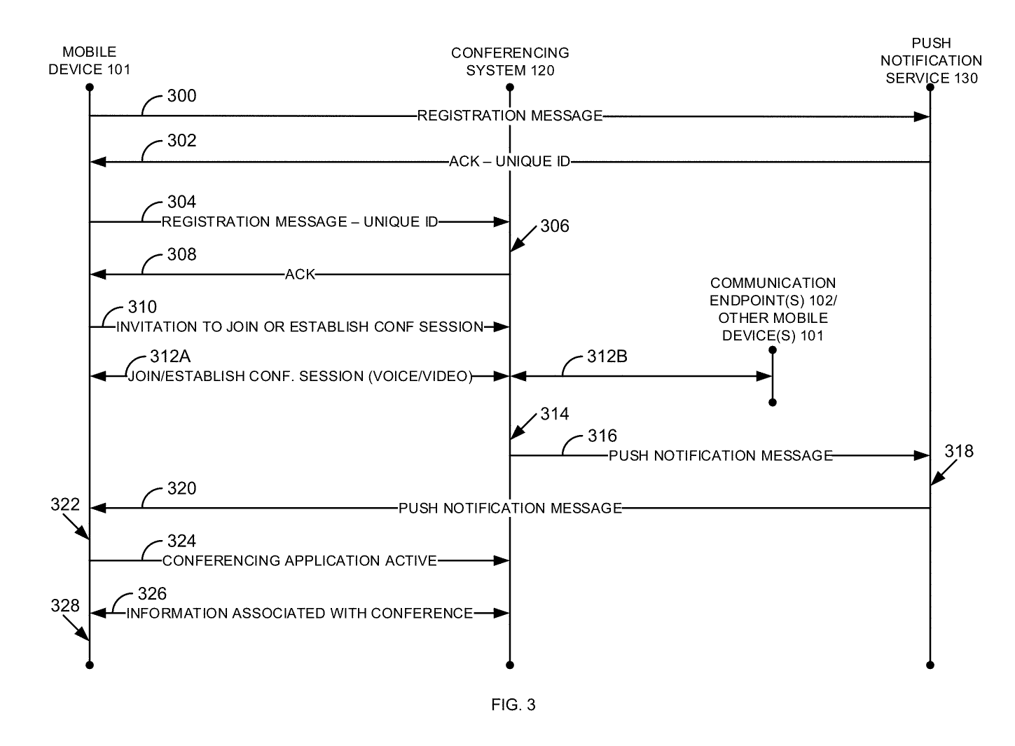

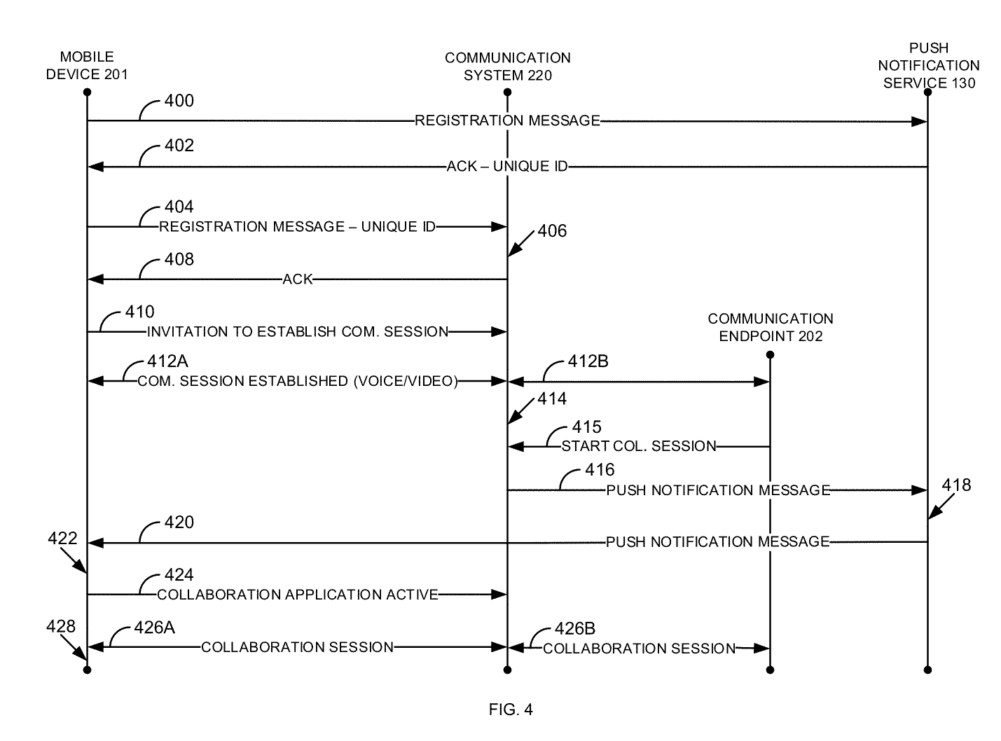

FIG. 3 is a flow diagram of a process for providing a rich user experience for cellular conference calls. Illustratively, the mobile device 101, the cell phone application 102, the conferencing application 103, the communication endpoints 102A-102N, the network 110, the conferencing system 120, the communication processor 121, the mixer 122, the conference manager 123, the push notification service(s) 130, the mobile device 201, the collaboration application 203, the telephone/video application 204, the communication system 220, the communication processor 221, the collaboration manager 222, and the collaboration page 223 are stored-program-controlled entities, such as a computer or microprocessor, which performs the method of FIGS. 3-4 and the processes described herein by executing program instructions stored in a computer readable storage medium, such as a memory (i.e., a computer memory, a hard disk, and/or the like). Although the methods described in FIGS. 3-4 are shown in a specific order, one of skill in the art would recognize that some or all of the steps in FIGS. 3-4 may be implemented in different orders and/or be implemented in a multi-threaded environment. Moreover, various steps may be omitted or added based on implementation.

The process of FIG. 3 is based on FIG. 1. The process starts, in step 300, where the mobile device 101 (the conferencing application 103) sends a registration message to the push notification service 130. The registration message of step 300 may be sent at various times. For example, the registration message of step 300 may be sent as part of an installation process for the conferencing application 103. Alternatively, the registration message of step 300 may be sent sometime after the conferencing application 103 is installed. For instance, when the conferencing application 103 is first brought up by a user. The registration message of step 300 is sent to register the conferencing application 103 with the push notification service 130. For example, the registration message of step 300 may be sent to an Apple® Push Notification service 130.

In response to receiving the registration message of step 300, the push notification service 130 sends an acknowledgement message in step 302 to the conferencing application 103. The acknowledgement message of step 302 includes a unique identifier. The unique identifier of step 302 uniquely identifies the conferencing application 103 in the mobile device 101 from other applications and from the same conferencing application 103 on another mobile device 101. For example, the unique identifier sent in step 302 will be different for the same conferencing application 103 that is running on another mobile device 101.

In response to receiving the unique identifier, the conferencing application 103 sends, in step 304, a registration message to the conferencing system 120 (the conference manager 123). The registration message of step 304 includes the unique identifier received in step 302. In addition, the registration message of step 304 may include other information, such as, a cellular telephone number of the mobile device 101, a user name, a caller Identifier (caller ID), a hardware identifier of the mobile device 101, other user/device information, and/or the like. The conference manager 123 stores, in step 306, the information received in step 304 (i.e., the unique identifier, the cellular telephone number, etc.). The conference manager 123 associates the unique identifier with the other received information (i.e., the cellular telephone number). In response to receiving the registration message of step 304, the conferencing system 120 (the conference manager 123) sends an acknowledgement message, in step 308, to the conferencing application 103 in the mobile device 101.

At a later point in time, the mobile device 101 (via the cell phone application 102) sends, in step 310, an invitation to join or establish a conference session. The conference session may include one or more of the communication endpoints 102A-102N and/or one or more additional mobile devices 101. The invitation of step 310 may be where a user of the mobile device 101 dials a number of the conferencing system 120 (e.g., a 1-800 number) using the built-in cell phone application 102 and then provides an access code to join a specific conference call. Alternatively, the invitation of step 310 may be to establish a conference session. For instance, the user may dial in and provide an access code that initiates a scheduled conference call by calling members of group defined in the user's calendar. The invitation of step 310 may be a request to establish a conference session with a communication endpoint (e.g., communication endpoint 102A). The invitation of step 310 may also include the cellular telephone number of the mobile device 101 and/or caller ID of the mobile device 101. Based on the invitation of step 310, the conference session is eventually joined or established in steps 312A-312B between the mobile device 101 and one or more of the communication endpoints 102A-102N and/or other mobile devices 101.

Although FIG. 3 shows that the user has joined the conference session or that the conference session is established before steps 314-324, one of skill in the art would recognize that steps 312A-312B may occur at any time before or after step 328 (e.g., in parallel with steps 314-328). The conference session may be an audio conference session, a video conference session, a virtual reality conference session, and/or the like.

The conference manager 123 determines, in step 314, that the invitation of step 310 is from a cellular network 110. The conference manager 123 can determine that the invitation of step 310 is from a cellular network 110 in various ways, such as, based on an administrative input of the cellular telephone number, based a query made to a provider of the cellular network (i.e., part of network 110), based on matching cellular telephone numbers, matching caller IDs, and/or the like. For example, when a query is made to the provider of the cellular network, if response indicates that the call is not a cellular call, the process ends after step 314. Otherwise, the received cellular telephone number can be matched with known cellular telephone numbers to identify the mobile device 101 and possibly a user of the mobile device.

In one embodiment, that the conference manager 123 matches the cellular telephone number and/or caller ID that was received in the registration message of step 304 (e.g., identified as a cellular telephone number in the registration message 304) to the cellular telephone number and/or caller ID received in step 310. In another embodiment, the conference manager 123 matches an administered cellular telephone number to the cellular telephone number received in step 310. If the two cellular telephone numbers match, in step 314, the conferencing application 123 sends, in step 316, a push notification message to the push notification service 130. The push notification message of step 316 also includes the unique identifier. The push notification message of step 316 may also include additional information for the conference session. For instance, the push notification message of step 316 may include the link to conference information 124, a Hypertext Transfer Protocol (HTTP) conference room link, a web collaboration link, a roster retrieval link, other related conference information, and/or the like.

The push notification service 130, matches, in step 318, the unique identifier in the push notification message of step 316 to the unique identifier sent in step 302. Based on the unique identifier, the push notification service 130 can send, in step 320, the push notification message to the mobile device 101 (that includes the conference information). In response to receiving the push notification message of step 320, the mobile device 101 activates, in step 322, the conferencing application 103. The conferencing application 103 sends, in step 324, a message that indicates that the conferencing application 103 is active to the conference manager 123. The message that the conferencing application 103 is active includes the unique identifier. The conference manager 123 may use the unique identifier to know what information needs to be sent to the conferencing application 103 (or other devices in the conference session). For example, the conference manager 123 can look up a user associated with the unique identifier to provide roster information for the conference session.

The conferencing application 103 can be active in various ways. For example, the conferencing application 103 can be activated by being launched by the mobile device 101. Alternatively, the conferencing application 103 may already be loaded and running before receiving the push notification message of step 320. The activation may be that the conferencing application 103 starts communicating (e.g., by sending message 324) with the conferencing system 120 or specifically sending of the activation message of step 324. In one embodiment, the conferencing application 103 may become active where the conferencing application 103 has been halted and starts running again. As part of the activation process the information in the push notification message of step 320 is passed to the conferencing application 103 (e.g., the link to conference information 124).

The conferencing application 103 then retrieves, in step 326, the information for the conference session to display to a user. The conferencing application 103 may retrieve the information for the conference session by going to the link to conference information 124, which causes the conference system 120 to send information associated with the conference session. Alternatively, the mobile device 101 may send a request message (i.e., in the conferencing application 103 active message 324) to request that the conference manager 123 send information about the conference session (e.g., roster information that can be sent in step 326). After receiving the information associated with the conference session in step 326, the mobile device 101 displays, in step 328, the information for the conference session to a user of the mobile device 101.

In one embodiment, the push notification message of step 316 may be sent to multiple push notification services 130. For example, the push notification message of step 316 may be sent to an Apple® Push Notification service 130 and a Google® Firebase Push Notification service 130 simultaneously. The message of step 324 is based on one of the push notification services 130 determining that the unique identifier is for the mobile device 101.

FIG. 4 is a flow diagram of a process for providing a rich user experience for cellular collaboration calls. The process of FIG. 4 is based on FIG. 2. The process starts, in step 400, where the mobile device 201 (the collaboration application 203) sends a registration message to the push notification service 130. The registration message of step 400 may be sent at various times. For example, the registration message of step 400 may be sent as part of an installation process for the collaboration application 203. Alternatively, the registration message of step 400 may be sent sometime after the collaboration application 203 is installed. For instance, when the collaboration application 203 is first brought up by a user. The registration message of step 400 is sent to register the collaboration application 203 with the push notification service 130. For example, the registration message of step 400 may be sent to an Apple® Push Notification service 130.

In response to the registration message of step 400, the push notification service 130 sends an acknowledgement message, in step 402, to the collaboration application 203. The acknowledgement message of step 402 includes a unique identifier. The unique identifier of step 402 uniquely identifies the collaboration application 203 in the mobile device 201 from other applications and from the same collaboration application 203 on another mobile device 201. For example, the unique identifier sent in step 402 will be different for the same conferencing application 203 that is running on another mobile device 201.

In response to receiving the unique identifier, the collaboration application 203 sends, in step 404, a registration message to the communication system 220 (the collaboration manager 222). The registration message of step 404 includes the unique identifier received in step 402. In addition, the registration message of step 404 may include other information, such as, a cellular telephone number of the mobile device 201, a user name, a hardware identifier of the mobile device 201, other user/device information, and/or the like. The collaboration manager 222 stores, in step 406, the information received in step 404 (i.e., the unique identifier, the cellular telephone number, etc.). The collaboration manager 222 associates the unique identifier with the other received information (i.e., the cellular telephone number). In response to receiving the registration message of step 404, the communication system 220 (the collaboration manager 222) sends an acknowledgement message, in step 408, to the collaboration application 203 in the mobile device 201.

At a later point in time, the mobile device 201 (via the cell phone application 102) sends, in step 410, a request to establish a communication session (e.g., a voice call) with the communication endpoint 202. Alternatively, the invitation of step 410 may be to establish a conference session. The invitation of step 410 also includes the cellular telephone number of the mobile device 201. Based on the invitation of step 410, the communication session between the mobile device 201 and the communication endpoint 202 is established in steps 412A-412B. The communication session may be an audio communication session, a video communication session, a virtual reality session, and/or the like.

Although not shown in FIG. 4, the establishment of the communication session may be based on the communication endpoint 202 sending a request to establish the communication session. The request from the communication endpoint 202 will have the cellular telephone number of the mobile device 201.

Although FIG. 4 shows that the communication session has been established before steps 414-428, one of skill in the art would recognize that steps 412A-412B may occur at any time before or after step 428 (e.g., in parallel with steps 414-428). In FIG. 4, the communication session is shown to be between the mobile device 201 and the communication endpoint 202. However, other communication endpoints 202/mobile devices 201 may be involved in the communication session.

In FIG. 4, the communication is shown to go from the mobile device 201 to the communication endpoint 202 via the communication system 220. In one embodiment, the communication session (i.e., a media stream of the communication session (e.g., voice data)) may be sent directly between the mobile device 201 and the communication endpoint 202.

The collaboration manager 222 determines, in step 414, that the invitation of step 410 is from a cellular network 110. The collaboration manager 222 can determine that the invitation of step 410 is from a cellular network 110 in various ways, such as, based on an administrative input of the cellular telephone number, based a query made to a provider of the cellular network (i.e., part of network 110), based on comparing cellular telephone numbers, and/or the like. For example, when a query is made to the provider of the cellular network, if response indicates that the call is not a cellular call, the process ends. Otherwise, the received cellular telephone number can be compared with known cellular telephone numbers to identify the mobile device 201 and possibly a user of the mobile device 201. Alternatively, the collaboration manager 222 may determine, in step 414, that a request from the communication endpoint 202 (like the message of step 410) is for the mobile device 201 on a cellular network.

In one embodiment, that the collaboration manager 222 compares the cellular telephone number that was received in the registration message of step 404 (e.g., identified as a cellular telephone number in the registration message 404) to the cellular telephone number received in step 410 (or a cellular telephone number received from the communication endpoint 202). In another embodiment, the collaboration manager 222 compares an administered cellular telephone number to the cellular telephone number received in step 410 (or a cellular telephone number received from the communication endpoint 202). If the two cellular telephone numbers match, in step 414, the collaboration manager 222 sends, in step 416, a push notification message to the push notification service 130. The push notification message of step 416 also includes the unique identifier. The push notification message of step 416 may also include additional information. For instance, the push notification message of step 416 may include a Hypertext Transfer Protocol (HTTP) link to the collaboration page 223.

In another embodiment, the push notification message of step 416 may be sent based on the collaboration manger 222 detecting one or more Dual Tone Multi-Frequency (DTMF) tones in the communication session between the mobile device 201 and the communication endpoint 202 (i.e., from a user of the mobile device 201 or a user of the communication endpoint 202). Alternatively, the push notification message of step 416 may be sent based on the communication endpoint 202, via the collaboration application 203 in the communication endpoint 202, sending a request in step 415 (e.g., initiated by a user clicking on a button in the collaboration application 203) to establish a collaboration session with the mobile device 201. In one embodiment, the request to start the collaboration session of step 415 includes a collaboration link (i.e. a link to a view of presentation displayed in the communication endpoint 202) that is then sent in the push notification message of step 416. In another embodiment, the push notification message of step 416 may include a link to a collaboration session that is for the mobile device 201. In this embodiment, the link for the collaboration session in the mobile device 201 may be initially sent in the registration message of step 404. The push notification message of step 416 may be sent on a combination of the above. For example, the push notification message of step 416 may be sent based on matching the two cellular telephone numbers (discussed above in step 414) and receiving a DTMF tone from a user of the mobile device 201.

The push notification service 130, matches, in step 418, the unique identifier in the push notification message of step 416 to the unique identifier sent in step 402. Based on the unique identifier, the push notification service 130 can send, in step 420, the push notification message to the mobile device 201 (that includes the collaboration information). In response to receiving the push notification message of step 420, the mobile device 201 activates, in step 422, the collaboration application 203. The collaboration application 203 sends, in step 424, a message that indicates that the collaboration application 203 is active to the collaboration manager 222. The message that the collaboration application 203 is active includes the unique identifier. The collaboration manager 222 may use the unique identifier to know what information needs to be sent to the collaboration application 203 (or other devices in the collaboration session).

The collaboration application 203 can be active in various ways. For example, the collaboration application 203 can be activated by being launched by the mobile device 201. Alternatively, the collaboration application 203 may already be loaded and running. The activation may be that the collaboration application 203 starts communicating (e.g., by sending message 424) with the communication system 220 or specifically sending of the activation message of step 424. In one embodiment, the collaboration application 203 may become active where the collaboration application 203 has been halted and starts running again. As part of the activation process the information in the push notification message of step 420 is passed to the collaboration application 203 (e.g., a link to the collaboration page 223).

The collaboration application 203 the retrieves, in step 424, the information for the collaboration session to display to a user. The collaboration application 203 may retrieve the information for the collaboration session by going to the collaboration web page 223. Alternatively, the collaboration application 203 may sent a message to request that the collaboration manager 222 send information about the collaboration session. After receiving the information associated with the collaboration session in step 426A, the mobile device 201 displays, in step 428, the information for the collaboration session to a user of the mobile device 201. The collaboration manger 222 may also send collaboration information/resources to the communication endpoint 202 in step 426B.

In one embodiment, the push notification message of step 416 may be sent to multiple push notification services 130. For example, the push notification message of step 416 may be sent to an Apple® Push Notification service 130 and a Google® Firebase Push Notification service 130 simultaneously. The message of step 424 is based on one of the push notification services 130 determining that the unique identifier is for the mobile device 201.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network 110, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system comprising:
a hardware microprocessor; and
a computer readable medium, coupled with the microprocessor and comprising microprocessor readable and executable instructions that program the microprocessor to:
receive an invitation, from a cell phone application in a mobile device, to join or establish a conference session;
determine that the invitation to join or establish the conference session is from a cellular network;
in response to determining that the invitation to join or establish the conference session is from the cellular network, send a push notification message to a push notification service, wherein the push notification service is external to the mobile device and wherein the push notification message causes an inactive conferencing application on the mobile device to become active;
receive a message from the conferencing application on the mobile device that the conferencing application is active; and
send information associated with the conference session to the conferencing application.

2. The system of claim 1, wherein the microprocessor readable and executable instructions further program the microprocessor to receive, from the conferencing application, a registration message, wherein the registration message comprises a unique identifier of the conferencing application and a cellular telephone number of the mobile device.

3. The system of claim 2, wherein the invitation to join or establish the conference session comprises the cellular telephone number of the mobile device and wherein the message that the conferencing application is active comprises the unique identifier of the conferencing application.

4. The system of claim 3, wherein the microprocessor readable and executable instructions further program the microprocessor to:
match the cellular telephone number of the mobile device received in the invitation to join or establish the conference session to the cellular telephone number of the mobile device received in the registration message; and
send the push notification message to the push notification service in response to the cellular telephone number of the mobile device received in the invitation to join or establish the conference session matching the cellular telephone number of the mobile device received in the registration message.

5. The system of claim 1, wherein the push notification message comprises a plurality of push notification messages sent to a plurality of push notification services and wherein the plurality of push notification services are separate push notification services that are external to the mobile device.

6. The system of claim 5, wherein plurality of push notification messages comprise a unique identifier of the conferencing application and wherein the received message that the conferencing application is active is based on the unique identifier of the conferencing application sent in one of the plurality of notification messages.

7. The system of claim 1, wherein determining that the invitation to join or establish the conference session from the cellular network is based on an administered cellular telephone number of the mobile device.

8. The system of claim 1, wherein determining that the invitation to join or establish the conference session from the cellular network is based on a query to a mobile carrier of the cellular network.

9. A method comprising:
receiving, by a microprocessor, an invitation from a cell phone application in a mobile device, to join or establish a conference session;
determining, by the microprocessor, that the invitation to join or establish the conference session is from a cellular network;
in response to determining that the invitation to join or establish the conference session is from the cellular network, sending, by the microprocessor, a push notification message to a push notification service, wherein the push notification service is external to the mobile device and wherein the push notification message causes an inactive conferencing application on the mobile device to become active;
receiving, by the microprocessor, a message from the conferencing application on the mobile device that the conferencing application is active; and
sending, by the microprocessor, information associated with the conference session to the conferencing application.

10. The method of claim 9, further comprising: receiving, by the microprocessor and from the conferencing application, a registration message, wherein the registration message comprises a unique identifier of the conferencing application and a cellular telephone number of the mobile device.

11. The method of claim 10, wherein the invitation to join or establish the conference session comprises the cellular telephone number of the mobile device and wherein the message that the conferencing application is active comprises the unique identifier of the conferencing application.

12. The method of claim 11, further comprising:
matching, by the microprocessor, the cellular telephone number of the mobile device received in the invitation to join or establish the conference session to the cellular telephone number of the mobile device received in the registration message; and
sending, by the microprocessor, the push notification message to the push notification service in response to the cellular telephone number of the mobile device received in the invitation to join or establish the conference session matching the cellular telephone number of the mobile device received in the registration message.

13. The method of claim 9, wherein the push notification message comprises a plurality of push notification messages sent to a plurality of push notification services and wherein the plurality of push notification services are separate push notification services that are external to the mobile device.

14. The method of claim 13, wherein plurality of push notification messages comprise a unique identifier of the conferencing application and wherein the received message that the conferencing application is active is based on the unique identifier of the conferencing application sent in one of the plurality of notification messages.

15. The method of claim 9, wherein determining that the invitation to join or establish the conference session from the cellular network is based on an administered cellular telephone number of the mobile device.

16. The method of claim 9, wherein determining that the invitation to join or establish the conference session from the cellular network is based on a query to a mobile carrier of the cellular network.

17. A system comprising:
a hardware microprocessor; and
a computer readable medium, coupled with the microprocessor and comprising microprocessor readable and executable instructions that program the microprocessor to:
receive an invitation, from an application, to establish a communication session between a mobile device and a communication endpoint;
determine that the invitation to establish the communication session is with the mobile device on a cellular network;
in response to determining that the invitation to establish the communication session is with the mobile device on the cellular network, send a push notification message to a push notification service, wherein the push notification service is external to the mobile device and wherein the push notification causes an inactive collaboration application on the mobile device to be active;
receive a message from the collaboration application on the mobile device that the collaboration application is active; and
in response to receiving the message that the collaboration application is active, establish a collaboration session between the mobile device and the communication endpoint.

18. The system of claim 17, wherein, sending the push notification message to the push notification service is initiated, at least in part, based on detecting one or more Dual Tone Multi-Frequency (DTMF) tones in the communication session.

19. The system of claim 17, wherein sending the push notification message to the push notification service is initiated, at least in part, based on a user input signal from the communication endpoint indicating to establish the collaboration session.

20. The system of claim 17, wherein sending the push notification message to the push notification service is initiated, at least in part, based on matching a cellular telephone number received in the invitation to establish the communication session to a cellular telephone number received in a registration message from the mobile device.
